(19) United States
(12) Patent Application Publication
(10) Pub. No.: US 2012/0064436 A1
(43) Pub. Date: Mar. 15, 2012

(54) INTERCONNECTING PLATE FOR SOLID OXIDE FUEL CELL AND MANUFACTURING METHOD THEREOF, AND SOLID OXIDE FUEL CELL USING THE INTERCONNECTING PLATE

(75) Inventors: Bon Seok KOO, Seoul (KR); Jong Sik YOON, Gyunggi-do (KR); Jae Hyuk JANG, Seoul (KR)

(73) Assignee: SAMSUNG ELECTRO-MECHANICS CO., LTD., Gyunggi-do (KR)

(21) Appl. No.: 12/972,212

(22) Filed: Dec. 17, 2010

(30) Foreign Application Priority Data
Sep. 13, 2010 (KR) 10-2010-0089215

(51) Int. Cl. H01M 8/12; H01M 4/04; H01M 4/66

(52) U.S. Cl. 429/488; 429/520; 429/535

(57) ABSTRACT

Disclosed herein are an interconnecting plate for a solid oxide fuel cell, a manufacturing method thereof, and a solid oxide fuel cell using the interconnecting plate. The interconnecting plate for a solid oxide fuel cell includes a metal substrate; and a conductive ceramic protective layer surrounding the metal substrate, wherein the ceramic protective layer is formed by disposing and stacking the metal substrate between a pair of ceramic sheets.

### CROSS REFERENCE TO RELATED APPLICATION

This application claims the benefit of Korean Patent Application No. 10-2010-0089215, filed on Sep. 13, 2010, entitled “Interconnecting Plate For Solid Oxide Fuel Cell And Manufacturing Method Thereof, And Solid Oxide Fuel Cell Using Said Interconnecting Plate” which is hereby incorporated by reference in its entirety into this application.

### BACKGROUND OF THE INVENTION

1. Technical Field

The present invention relates to an interconnecting plate for a solid oxide fuel cell, a manufacturing method thereof, and a solid oxide fuel cell using the interconnecting plate.

2. Description of the Related Art

A solid oxide fuel cell is operated at the highest temperature (700 to 1000° C.) among fuel cells using solid oxide having oxygen or hydrogen ion conductivity as an electrolyte and all components of the solid oxide fuel cell are made of solid, such that it has a simpler structure, does not lead to problems, such as the loss, supplement, corrosion of the electrolyte, does not require a noble metal catalyst, and facilitates the supply of fuel by direct internal reforming, as compared to other fuel cells. Further, the solid oxide fuel cell discharges high-temperature gas, such that it can perform a cogeneration plant using waste heat.

Due to these advantages, research into the solid oxide fuel cell has been actively conducted in advanced countries such as the USA, Japan, or the like, for the purpose of commercialization at the beginning of the 21st century.

A general solid oxide fuel cell is configured to include an electrolyte layer of high oxygen ion conductivity and porous cathode and anode layers positioned at both sides thereof. The operational principle transmits oxygen in the porous cathode and reaches the electrolyte surface and moves oxygen ion generated by the reduction reaction of oxygen to the anode through the dense electrolyte and then, reacts with hydrogen supplied to the porous anode, thereby generating water. In this case, since electrons are generated in the anode and electrons are consumed in the cathode, electricity flows when two electrodes are connected to each other.

In order to actually use electricity generated by the operational principle, since it has a predetermined level of voltage and current, the entire system is configured by being manufactured into a bundle and a stack connected in series and in parallel by using several unit cells as an interconnecting plate.

In order to collect electricity generated from each component, it is preferable to collect electricity using a metal interconnecting plate with excellent conductivity but the oxidization reaction of the metal interconnecting plate is easily promoted under the high-temperature oxidization atmosphere between 650 to 1000, which is the operational temperature of the fuel cell, to easily form an oxide film, thereby deteriorating electric conductivity.

Therefore, in order to secure the durability and the electric conductivity under the fuel cell operating environment, a conductive protective layer formed by coating a protective layer made of a ceramic material such as lanthanum chromites, yttrium chromites, etc., on the metal interconnecting plate has been used.

As a method for forming the protective layer (coating layer) of the existing interconnecting material for the fuel cell, there are largely a dip coating, plasma spray, or sputter, or the like.

First, when the dip-coating is used, slurry is manufactured by using a conductive ceramic powder to be coated, a drying layer is formed by subjecting to the interconnecting plate dried and dipped several times, and the dense coating layer is formed through a sintering. In this case, it is not easy to accurately control the thickness of the coating layer and in order to obtain the predetermined thickness, the dipping and drying should be performed several times, such that the manufacturing time is long and it is difficult to form the thick coating layer.

Meanwhile, when using the plasma spray is used, since the coating powder is melted and then, is sprayed and coated on the metal plate, there is a problem in that the composition of the final coating layer is different when volatile materials such as Cr are included in the powder component. Further, since the coating layer is formed by the spraying, there are problems in that the surface of the coating layer is uneven and it is difficult to control the thickness of the coating.

As such, there are problems in that the existing methods, such as dip-coating, plasma-spray, sputter, etc., have a complicated process and consume a great deal of time and cost.

### SUMMARY OF THE INVENTION

The present invention has been made in an effort to provide an interconnecting plate for a solid oxide fuel cell capable of improving productivity and saving cost according to process simplification by forming a protective layer for an interconnecting plate using a conductive ceramic sheet and a manufacturing method thereof.

Further, the present invention has been made in an effort to provide an interconnecting plate for a solid oxide fuel cell capable of improving durability of metal and maintaining excellent electric conductivity under high-temperature oxidation atmosphere by forming a dense protective layer, as compared to the existing method such as the plasma spray or the dip coating, and a manufacturing method thereof.

In addition, the present invention has been made in an effort to provide a solid oxide fuel cell using the interconnecting plate.

An interconnecting plate for a solid oxide fuel cell according to a preferred embodiment of the present invention includes: a metal substrate; and a conductive ceramic protective layer surrounding the metal substrate, wherein the conductive ceramic protective layer is formed by disposing and stacking the metal substrate between a pair of ceramic sheets.

The ceramic protective layer may include Co—Mn-based spinel compound, Peroveskite compound, or a combination thereof.

The ceramic protective layer may include a first conductive ceramic protective layer surrounding the metal substrate and a second conductive ceramic protective layer surrounding the first conductive ceramic protective layer.

The first conductive ceramic protective layer may include Co—Mn-based spinel compound and the second conductive ceramic protective layer includes Peroveskite compound.

The metal substrate may include a metal selected from a group consisting of titanium, stainless steel, copper, nickel, iron, or an alloy thereof.

A manufacturing method of an interconnecting plate for a solid oxide fuel cell according to another preferred embodiment of the present invention includes: preparing a metal substrate; preparing a pair of first conductive ceramic sheets; and obtaining a first laminate by disposing and stacking the substrate between the pair of first conductive ceramic sheets.

The manufacturing method of an interconnecting plate for a solid oxide fuel cell may further include: after obtaining the first laminate by stacking the first conductive ceramic sheets, preparing a pair of second conductive ceramic sheets; and obtaining a second laminate by disposing and stacking the first laminate between the pair of second conductive ceramic sheets.

The manufacturing method of an interconnecting plate for a solid oxide fuel cell may further include: after obtaining the first laminate, degreasing and burning the first laminate.

The manufacturing method of an interconnecting plate for a solid oxide fuel cell may further include: after obtaining the second laminate, degreasing and burning the second laminate.

The first conductive ceramic sheet and the second conductive ceramic sheet may be formed by a tape casting method.

The first ceramic sheet may include Co—Mn-based spinel compound, Peroveskite compound, or a combination thereof.

The first conductive ceramic sheet may include Co—Mn-based spinel compound and the second conductive ceramic sheet includes Peroveskite compound.

A solid oxide fuel cell according to another preferred embodiment of the present invention includes: an interconnecting plate including a metal substrate and a conductive ceramic protective layer surrounding the metal substrate and formed by disposing and stacking the metal substrate between a pair of ceramic sheets.

### BRIEF DESCRIPTION OF THE DRAWINGS

FIG. 1 is a cross-sectional view for schematically explaining an interconnecting plate for a solid oxide fuel cell according to a preferred embodiment of the present invention;

FIG. 2 is a cross-sectional view for schematically explaining an interconnecting plate for a solid oxide fuel cell according to another preferred embodiment of the present invention;

FIGS. 3 and 4 are schematic process flow charts for explaining a manufacturing method of an interconnecting plate for a solid oxide fuel cell according to a preferred embodiment of the present invention; and

FIGS. 5 to 8 are schematic process flow charts for explaining a manufacturing method of an interconnecting plate for a solid oxide fuel cell according to another preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as to obscure the subject of the present invention. Terms used in the specification, ‘first’, ‘second’, etc. can be used to describe various components, but the components are not to be construed as being limited to the terms. The terms are only used to differentiate one component from other components.

Hereinafter, a preferred embodiment of the present invention will be described in detail with reference to the accompanying drawings.

Interconnecting Plate for Solid Oxide Fuel Cell

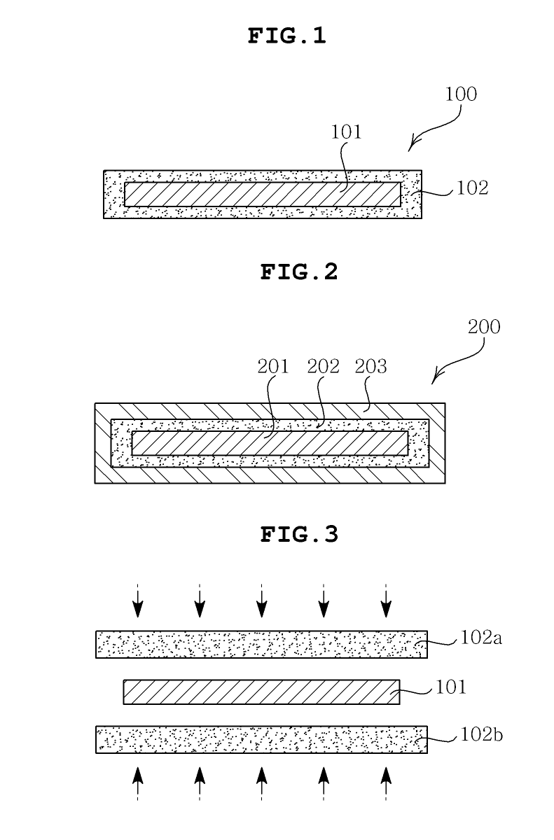

FIG. 1 is a cross-sectional view for schematically explaining an interconnecting plate for a solid oxide fuel cell according to a preferred embodiment of the present invention and FIG. 2 is a cross-sectional view for schematically explaining an interconnecting plate for a solid oxide fuel cell according to another preferred embodiment of the present invention.

Referring to FIG. 1, an interconnecting plate 100 for a solid oxide fuel cell according to a first preferred embodiment of the present invention includes a metal substrate 101 and a conductive ceramic protective layer 102 surrounding the metal substrate 101.

The interconnecting plate 100 for the solid oxide fuel cell is a metal interconnecting plate which collects electricity generated by connecting between unit cells at the time of manufacturing the bundle and stack of the fuel cell and is used to collect electricity generated at the time of collecting electricity or in the entire generation system, which has a conductive oxidation-resistant protective layer.

The metal substrate 101 may include metals selected from a group consisting of titanium, stainless steel, copper, nickel, iron, or an alloy thereof. For example, as known in the art, a metal plate, such as crofer, Fe—Ni-based superalloys, etc., may be used, but is not specifically limited thereto.

The ceramic protective layer 102 may include Co—Mn based spinel compound, Perovskite compound, or a combination thereof.

The spinel compound may be represented by MnₓCO₃₋ₓ, wherein 1≦x≦2.

The Perovskite compound may be represented by ABO₃, wherein A represents rare earth metal and alkali earth metal, B represents transition metal, and O represents oxygen. An example of the Perovskite compound may include LaCrO₃/YCrO₃ which is doped or not doped with alkali earth metal such as Sr, Ca, Co, etc., but is not specifically limited thereto.

The ceramic protective layer 102 is formed by disposing and stacking the metal substrate 101 between a pair of ceramic sheets to form a dense coating layer. Therefore, the ceramic protective layer 102 has excellent durability and electric conductivity as compared to the existing interconnecting plate to reduce loss during a current collecting process, thereby making it possible to improve the performance and long-term durability of the fuel cell.

In addition, a sheet can be accurately manufactured at a desired thickness, i.e., 1 μm or less, thereby making it possible to form the protective layer at an accurate thickness. The width and length of the sheet can be easily controlled, such that the protective layer can also be easily formed for a metal substrate having a wide area.

Referring to FIG. 2, an interconnecting plate 200 for a solid oxide fuel cell according to a second preferred embodiment of the present invention includes a metal substrate 201, a first conductive ceramic protective layer 202 surrounding the metal substrate 202, and a second conductive ceramic protective layer 203 surrounding the first conductive ceramic protective layer 202.

The interconnecting plate 200 for the solid oxide fuel cell is a metal interconnecting plate which collects electricity generated by connecting between unit cells at the time of manufacturing the bundle and stack of the fuel cell and is used to collect electricity generated at the time of collecting electricity or in the entire generation system, which has a conductive oxidation-resistant protective layer.

The metal substrate 201 may include metals selected from a group consisting of titanium, stainless steel, copper, nickel, iron, or an alloy thereof. For example, as known in the art, a metal plate, such as crofer, Fe—Ni-based superalloys, etc., may be used, but is not specifically limited thereto.

The first conductive ceramic protective layer 202 and the second conductive ceramic protective layer 203 may include Co—Mn-based spinel compound, Perovskite compound, or a combination thereof.

The spinel compound may be represented by MnₓCO₃₋ₓ, wherein 1≦x≦2.

The Perovskite compound may be represented by ABO₃, wherein A represents rare earth metal and alkali earth metal, B represents transition metal, and O represents oxygen. An example of the Perovskite compound may include LaCrO₃/YCrO₃ which is doped or not doped with alkali earth metal such as Sr, Ca, Co, etc., but is not specifically limited thereto.

The first ceramic protective layer 202 is formed by disposing and stacking the metal substrate 201 between a pair of ceramic sheets to form a dense coating layer. Therefore, the first ceramic protective layer 202 has excellent durability and electric conductivity as compared to the existing interconnecting plate to reduce loss during a current collecting process, thereby making it possible to improve the performance and long-term durability of the fuel cell.

In addition, a sheet can be accurately manufactured at a desired thickness, i.e., 1 μm or less, thereby making it possible to form the protective layer at an accurate thickness. The width and length of the sheet can be easily controlled, such that the protective layer can also be easily formed for a metal substrate having a wide area.

In addition, the second conductive ceramic protective layer 203 may be formed by disposing and stacking the metal substrate 201 formed with the first conductive ceramic protective layer 202 between another pair of ceramic sheets. In this case, the second conductive ceramic protective layer 203 may be formed of a material different from that of the first conductive ceramic protective layer 202. In addition, as described above in the first preferred embodiment, the second conductive ceramic protective layer 203 can be easily controlled at a desired thickness.

For example, the first conductive ceramic protective layer 202 may be configured to include Co—Mn-based spinel compound and the second conductive ceramic protective layer 203 may be configured to include Perovskite compound.

However, FIG. 2 shows only the case where the ceramic protective layer is configured of a two-layer but it can be sufficiently appreciated from those skilled in the art that the ceramic protective layer can be configured of a multi-layer of three layers or more according to the actual purpose.

Manufacturing Method of Interconnecting Plate for Solid Oxide Fuel Cell

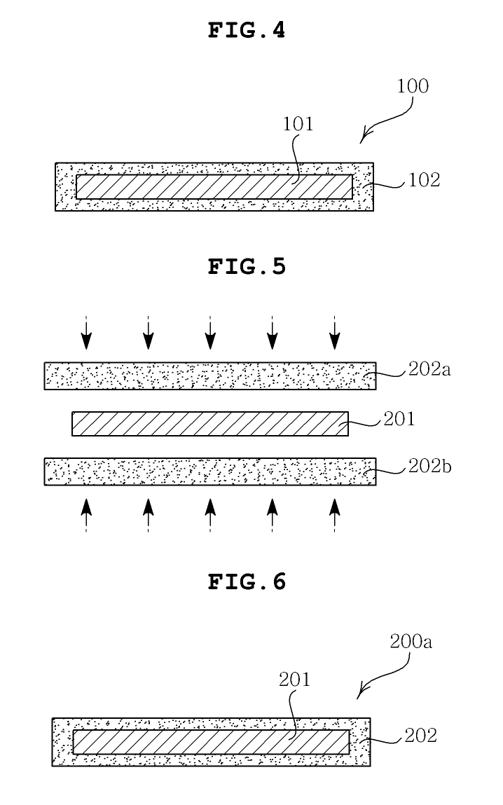

FIGS. 3 and 4 are schematic process flow charts for explaining a manufacturing method of an interconnecting plate for a solid oxide fuel cell according to a preferred embodiment of the present invention and FIGS. 5 to 8 are schematic process flow charts for explaining a manufacturing method of an interconnecting plate for a solid oxide fuel cell according to another preferred embodiment of the present invention.

Hereinafter, a manufacturing method of an interconnecting plate of a solid oxide fuel cell according to a first preferred embodiment of the present invention will be described with reference to FIGS. 3 and 4.

Referring first to FIG. 3, the metal substrate 101 and a pair of conductive ceramic sheets 102a and 102b are prepared and the substrate 101 is disposed between the pair of conductive ceramic sheets 102a and 102b.

The metal substrate 101 may include metals selected from a group consisting of titanium, stainless steel, copper, nickel, iron, or an alloy thereof. For example, as known in the art, a metal plate, such as crofer, Fe—Ni-based superalloys, etc., may be used, but is not specifically limited thereto.

The conductive ceramic sheets 102a and 102b may be formed by a general tape casting method. In addition to this, the conductive ceramic sheets 102a and 102b may be manufactured by a method of drying a sheet by heat-drying a mixture of binder, ceramic powder, and solvent, a method of manufacturing a sheet by exposure instead of drying using a photosensitive material, a method of using an inkjet, or the like. However, the general methods of manufacturing the ceramic sheet known in the art can be used without being limited to the foregoing methods.

For example, the tape casting method applied to the present invention, which is a general sheet manufacturing method used for manufacturing the ceramic components such as MLCC, may manufacture the ceramic power into a thick film type.

The tape casting method includes a process of making the ceramic powder into slurry.

In this case, the used ceramic powder is a powder in the range of, for example, BET 2 to 10. The kind of ceramic powder may include Co—Mn-based spinel compound, Perovskite compound, or a combination thereof, which are material configuring the ceramic sheet similar to the ceramic protective layer.

The spinel compound may be represented by MnxCO3−x, wherein 1≦x≦2.

The Perovskite compound may be represented by ABO₃, wherein A represents rare earth metal and alkali earth metal, B represents transition metal, and O represents oxygen. An example of the Perovskite compound may include LaCrO₃/YCrO₃ which is doped or not doped with alkali earth metal such as Sr, Ca, Co, etc., but is not specifically limited thereto.

Meanwhile, it may be manufactured at a thickness between about 15 to 500 μm according to the applied purpose after mixing components such as solvent, dispersant, and plasticizer using PVB, PVA, acrylic-based binder, etc., during the slurry process, without being specifically limited thereto.

Hereinafter, the tape casting method will be described by way of example but is not limited thereto.

For example, primary slurry is prepared by mixing the solvent giving flowability to the ceramic powder with the dispersant to uniformly distribute each powder in the slurry.

Thereafter, a secondary slurry is prepared by adding a crosslinker serving to maintain a molding shape in prepared primary slurry up to the sintering process and adding plasticizer in order to impart flowability to facilitate casting or impart flexibility to a molding product and mixing them. In this case, the secondary slurry may be prepared by selectively adding a releasing agent to be easily removed from the carrier tape after being prepared and an adhesive in order to increase adhesion for adhesive objects, or the like. In this case, if the adhesive and the releasing agent are previously applied to the carrier tape, they may not be added.

The finally prepared secondary slurry is prepared as a green tape using the tape casting process and the thickness of the prepared green tape is controlled by controlling doctor blade and the transferring rate of the carrier tape, thereby making it possible to form the green tape on the carrier tape.

The method for manufacturing the green tape using the tape casting process has advantages in a simple manufacturing in order to facilitate storage, transportation, etc., by giving plastic property to the green tape, in particular, the continuous process, and the mass production. In addition, the green tape may facilitate molding and modifying into a desired shape after drying the green tape and therefore, may be manufactured into a predetermined shape according to the actual use purpose.

As described above, when the protective layer of the metal interconnecting plate is formed using the ceramic sheet, the dense protective layer can be formed, which has excellent durability and electric conductivity as compared to the existing interconnecting plate to reduce loss during a current collecting process, thereby making it possible to improve the performance and long-term durability of the fuel cell.

In addition, the manufacturing process is simplified and the sheet can be accurately manufactured at a desired thickness, i.e., 1 μm or less, thereby making it possible to form the protective layer at an accurate thickness. The width and length of the sheet can be easily controlled, such that the protective layer can also be easily formed for a metal substrate having a wide area.

Next, referring to FIG. 4, the interconnecting plate 100 including the conductive ceramic protective layer 102 surrounding the metal substrate 101 may be manufactured by stacking the pair of conductive ceramic sheets 102a and 102b disposed on both surfaces of the metal substrate 101.

The stacking process may combine the conductive ceramic sheets 102a and 102b with the metal substrate 101 by applying heat between 40 to 150 and pressure between 1 to 300 MPa using an isostatic press, or the like.

In addition, according to the foregoing description, when the bonding between the ceramic sheets 102a and 102b and the metal substrate 101 is completed, it is possible to form the dense layer through the general degreasing and burning process in, for example, the heat-treating furnace.

Hereinafter, a manufacturing method of an interconnecting plate for a solid oxide fuel cell according to a second preferred embodiment of the present invention will be described with reference to FIGS. 5 to 8.

First, referring to FIG. 5, a metal substrate 201 and a pair of first conductive ceramic sheets 202a and 202b are prepared and the substrate 201 is disposed between the pair of first conductive ceramic sheets 202a and 202b. In this configuration, the metal substrate and the first conductive ceramic sheet were described in the first preferred embodiment.

Next, referring to FIG. 6, a first laminate 200a including the first conductive ceramic protective layer 202 surrounding the metal substrate 201 may be manufactured by stacking the pair of first conductive ceramic sheets 202a and 102b disposed on both surfaces of the metal substrate 201, as described above. The stacking process was described in the first preferred embodiment.

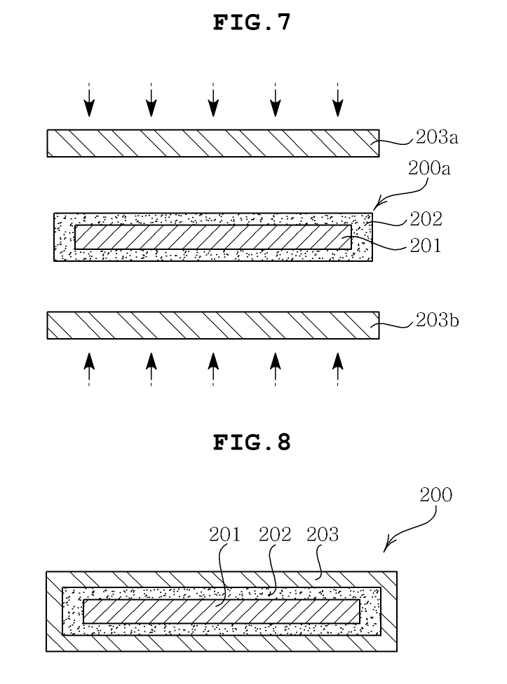

Next, referring to FIG. 7, the first laminate 200a obtained in FIG. 6 is disposed between the pair of second conductive ceramic sheets 203a and 203b.

In this case, as the second conductive ceramic sheets 203a and 203b, a sheet manufactured according to the same method as the first conductive ceramic sheets 202a and 202b may be used.

However, the material of forming the first conductive ceramic sheets 202a and 202b and the second conductive ceramic sheets 203a and 203b may be generally different from each other according to the actual use purpose. For example, the first conductive ceramic sheets 202a and 202b may be manufactured to include the Co—Mn-based spinel compound and the second conductive ceramic sheets 203a and 203b may be manufactured to include the Perovskite compound but are not specifically limited thereto.

Next, referring to FIG. 8, the interconnecting plate 200 including a metal substrate 201, a first conductive ceramic protective layer 202 surrounding the metal substrate 201, and a second conductive ceramic protective layer 203 surrounding the first conductive ceramic protective layer 202 may be manufactured by stacking a pair of second conductive ceramic sheets 203a and 203b. The stacking process is described previously.

In addition, when the bonding between the first conductive ceramic protective layer 202 and the second conductive ceramic sheets 203a and 203b is completed as described above, the dense film may be formed by the general degreasing and burning processes in, for example, the heat-treatment furnace.

Although the second preferred embodiment describes, by way of example, only the case where two pair of ceramic sheets are applied, those skilled in the art can sufficiently appreciated that the interconnecting plate may be manufactured by applying three pairs of ceramic sheets according to the above-mentioned method.

In addition, when forming the multi-layer ceramic protective layer, each degreasing and burning process will be omitted during a process of forming each protective layer and after forming the protective layer that is an outermost layer, the degreasing and burning process may be performed once.

Solid Oxide Fuel Cell

The solid oxide fuel cell according to a preferred embodiment of the present invention includes a metal substrate, a conductive ceramic protective layer surrounding the metal substrate, and an interconnecting plate formed by disposing and stacking the metal substrate between a pair of ceramic sheets.

The interconnecting plate 200 for the solid oxide fuel cell is a metal interconnecting plate which collects electricity generated by connecting between unit cells at the time of manufacturing the bundle and stack of the fuel cell and is used to collect electricity generated at the time of collecting electricity or in the entire generation system, which has a conductive oxidation-resistant protective layer The structure of the interconnecting plate and the manufacturing method used in the present invention are described above.

As other components of the solid oxide fuel cell, the general components known to those skilled in the art may be used without limitation.

According to the preferred embodiment of the present invention, it forms the protective layer of the metal interconnecting plate using the conductive ceramic sheet to form the dense coating layer, thereby making it possible to provide the solid oxide fuel cell having excellent durability and electric conductivity under the high-temperature oxidation atmosphere as compared to the existing methods.

In addition, the present invention can reduce the loss during the current collecting process, thereby making it possible to improve the performance and long-term durability of the fuel cell.

Further, the present invention can improve the productivity and save the costs according to the process simplification.

According to another preferred embodiment of the present invention, the sheet can be accurately manufactured at a desired thickness, i.e., 1 μm or less by using the tape casting, thereby making it possible to accurately form the thickness of the coating layer and can easily control the width and length of the sheet to be coated over a wide area, thereby making it possible to increase the productivity.

Although the preferred embodiments of the present invention have been disclosed for illustrative purposes, they are for specifically explaining the present invention and thus an interconnecting plate for solid oxide fuel cell and a manufacturing method thereof, and a solid oxide fuel cell using the interconnecting plate according to the present invention are not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. An interconnecting plate for a solid oxide fuel cell, comprising:
a metal substrate; and
a conductive ceramic protective layer surrounding the metal substrate,
wherein the ceramic protective layer is formed by disposing and stacking the metal substrate between a pair of ceramic sheets.

2. The interconnecting plate for a solid oxide fuel cell as set forth in claim 1, wherein the ceramic protective layer includes a first conductive ceramic protective layer surrounding the metal substrate and a second conductive ceramic protective layer surrounding the first conductive ceramic protective layer.

3. The interconnecting plate for a solid oxide fuel cell as set forth in claim 1, wherein the metal substrate includes a metal selected from a group consisting of titanium, stainless steel, copper, nickel, iron, or an alloy thereof.

4. The interconnecting plate for a solid oxide fuel cell as set forth in claim 1, wherein the ceramic protective layer includes Co—Mn-based spinel compound, Peroveskite compound, or a combination thereof.

5. The interconnecting plate for a solid oxide fuel cell as set forth in claim 2, wherein the first conductive ceramic protective layer includes Co—Mn-based spinel compound and the second conductive ceramic protective layer includes Peroveskite compound.

6. A manufacturing method of an interconnecting plate for a solid oxide fuel cell, comprising:
preparing a metal substrate;
preparing a pair of first conductive ceramic sheets; and
obtaining a first laminate by disposing and stacking the substrate between the pair of first conductive ceramic sheets.

7. The manufacturing method of an interconnecting plate for a solid oxide fuel cell as set forth in claim 6, further comprising: after obtaining the first laminate by stacking the first conductive ceramic sheets,
preparing a pair of second conductive ceramic sheets; and
obtaining a second laminate by disposing and stacking the first laminate between the pair of second conductive ceramic sheets.

8. The manufacturing method of an interconnecting plate for a solid oxide fuel cell as set forth in claim 6, further comprising: after obtaining the first laminate,
degreasing and burning the first laminate.

9. The manufacturing method of an interconnecting plate for a solid oxide fuel cell as set forth in claim 7, further comprising: after obtaining the second laminate,
degreasing and burning the second laminate.

10. The manufacturing method of an interconnecting plate for a solid oxide fuel cell as set forth in claim 6, wherein the first conductive ceramic sheet is formed by a tape casting method.

11. The manufacturing method of an interconnecting plate for a solid oxide fuel cell as set forth in claim 7, wherein the second conductive ceramic sheet is formed by a tape casting method.

12. The manufacturing method of an interconnecting plate for a solid oxide fuel cell as set forth in claim 6, wherein the metal substrate includes a metal selected from a group consisting of titanium, stainless steel, copper, nickel, iron, or an alloy thereof.

13. The manufacturing method of an interconnecting plate for a solid oxide fuel cell as set forth in claim 6, wherein the first ceramic sheet includes Co—Mn-based spinel compound, Peroveskite compound, or a combination thereof.

14. The manufacturing method of an interconnecting plate for a solid oxide fuel cell as set forth in claim 7, wherein the first conductive ceramic sheet includes Co—Mn-based spinel compound and the second conductive ceramic sheet includes Peroveskite compound.

15. A solid oxide fuel cell, comprising:
an interconnecting plate including a metal substrate and a conductive ceramic protective layer surrounding the metal substrate and formed by disposing and stacking the metal substrate between a pair of ceramic sheets.

16. The solid oxide fuel cell as set forth in claim 15, wherein the ceramic protective layer includes a first conductive ceramic protective layer surrounding the metal substrate and a second conductive ceramic protective layer surrounding the first conductive ceramic protective layer.

17. The solid oxide fuel cell as set forth in claim 15, wherein the metal substrate is selected from a group consisting of titanium, stainless steel, copper, nickel, iron, or an alloy thereof.

18. The solid oxide fuel cell as set forth in claim 15, wherein the ceramic protective layer includes Co—Mn-based spinel compound, Peroveskite compound, or a combination thereof.

19. The solid oxide fuel cell as set forth in claim 16, wherein the first conductive ceramic protective layer includes Co—Mn-based spinel compound and the second conductive ceramic protective layer includes Peroveskite compound.
